(19) United States
(12) Patent Application Publication
(10) Pub. No.: US 2011/0213707 A1
(43) Pub. Date: Sep. 1, 2011

(54) SYSTEMS AND METHODS FOR FACILITATING PERSON-TO-PERSON PAYMENTS

(75) Inventors: Justin Ryan Jackson, Lewis Center, OH (US); Andrew Montgomery Litt, Plain City, OH (US); Todd Nathaniel Roberts, Granville, OH (US); Christopher Dean Stroud, Columbus, OH (US)

(73) Assignee: FISERV, INC., Brookfield, WI (US)

(21) Appl. No.: 12/714,658

(22) Filed: Mar. 1, 2010

(51) Int. Cl. G06Q 20/00; G06Q 40/00; G06F 17/00; G06F 15/16; G06F 17/30

(52) U.S. Cl. 705/44; 705/39; 715/205; 709/238; 707/769; 707/E17.014

(57) ABSTRACT

Embodiments of the invention may provide systems and methods for facilitating person-to-person payments. A payer request to pay a payee identified by a first contact identifier is received. Upon failing to locate the payee in a data repository of registered payees via the first contact identifier, the first contact identifier is utilized to transmit a registration invitation to the payee. Information associated with the request may be stored pending registration by the payee, and the invitation may include a link to a payment service provider site and an indicator of the stored information. Based upon a payee selection of the link, the indicator and identifying information for the payee other than the first contact identifier is received. The received identifying information is utilized to determine a pre-existing registration of the payee with the payment service provider, and the stored information is utilized to direct a payment to the payee.

### FIELD OF THE INVENTION

Aspects of the invention relate generally to monetary payments, and more particularly to systems and methods for facilitating person-to-person payments.

### BACKGROUND OF THE INVENTION

Several electronic payment service providers offer services that support person-to-person payments. These personal payment services are typically made available via a Web interface or in conjunction with a financial application. Payments submitted through a personal payment service are typically fully electronic payments that result in an electronic debit from a funding account of a payer and an electronic credit into an account of a payee. Accordingly, both the payer and the payee are typically required to have a registration with a personal payment service provider that allows the service provider to effectuate payments.

When requesting a payment, a payer typically identities a payee via some contact identifier, such as a user identifier, telephone number, or email address. However, in certain situations, a payer may request a payment utilizing a contact identifier for a payee that is different than a contact identifier for the payee that was utilized to register the payee for a personal payment service. For example, a payer may request a payment utilizing an email address of a payee, and the payee may be registered with the personal payment service under a telephone number or a different email address. In such a situation, conventional payment systems may require the payee to re-register with the personal payment service in order to receive a payment, leading to multiple accounts for a single payer and potentially reducing consumer satisfaction for the payee.

### BRIEF DESCRIPTION OF THE DRAWINGS

Reference will now be made to the accompanying drawings, which are not necessarily drawn to scale, and wherein:

FIG. 1 illustrates an overview of an example system for facilitating person-to-person payments, according to an example embodiment of the invention.

FIGS. 2-4 illustrate example data flows for facilitating a person-to-person payment by a personal payment service system, according to example embodiments of the invention.

FIG. 5 is a flow chart of an example method for facilitating a person-to-person payment, according to an example embodiment of the invention.

### DETAILED DESCRIPTION

The invention will now be described more fully hereinafter with reference to the accompanying drawings, in which example embodiments of the invention are shown. This invention may, however, be embodied in many different forms and should not be construed as limited to the example embodiments set forth herein; rather, these example embodiments are provided so that this disclosure will be thorough and complete, and will fully convey the scope of the invention to those of ordinary skill in the art. Like numbers refer to like elements throughout.

Embodiments of the invention may provide systems and methods for facilitating person-to-person payments. In one example embodiment, a request on behalf of a payer to pay a payee may be received, the request identifying the payee via a first contact identifier, such as a telephone number, email address, social networking site identifier, etc. Upon failing to locate the payee in a data repository of registered payees via the first contact identifier, an invitation to register with a payment service provider to receive a payment corresponding to the request may be transmitted to the payee utilizing the first contact identifier. Information associated with the request may be stored pending registration by the payee, and the invitation may include a link or address to a site of the payment service provider (or other contact information for the payment service provider) and an indicator of the stored information. Based at least in part upon a payee navigating to the site of the payment service provider (or otherwise contacting the service provider), such as by selection of the link, identifying information for the payee other than the first contact identifier and the indicator of the stored information may be received. For example, identifying information for the payee may be provided to the payment service provider by the payee or by a financial institution associated with the payee. The received identifying information may be utilized to determine a pre-existing registration of the payee with the payment service provider, the pre-existing registration being associated with a second contact identifier and a financial account at a financial institution for receiving funds. The stored information for the payment request may then be utilized in association with the pre-existing registration to direct a payment to the payee by crediting funds into the financial account.

As used herein, the term “subscriber” generally refers to an individual that is enrolled or registered with a personal payment service. As such, the subscriber may be a registered user of the personal payment service that is capable of making and/or receiving payments via the personal payment service. Also as used herein, the term “payer” generally refers to a subscriber requesting or otherwise providing payment to another individual. Thus, the term “payee” generally refers to an individual receiving payment, such as may be received via an electronic payment application provided by the personal payment service. The term “personal payment service (PPS) provider” generally refers to an entity operable to process payment requests made by payers and effectuate or direct payments to payees. The PPS provider may include any number of systems and or processing components, which may generally be referred to as a “PPS system,” to facilitate the processing of payment requests. Payment requests can be received by a PPS system directly from a payer subscriber, or from any other entity on behalf of a subscriber. Though, according to some embodiments, a service provider is not limited to a PPS provider, and can generally refer to any entity facilitating transactions with other entities on behalf of its customers.

I. System Overview

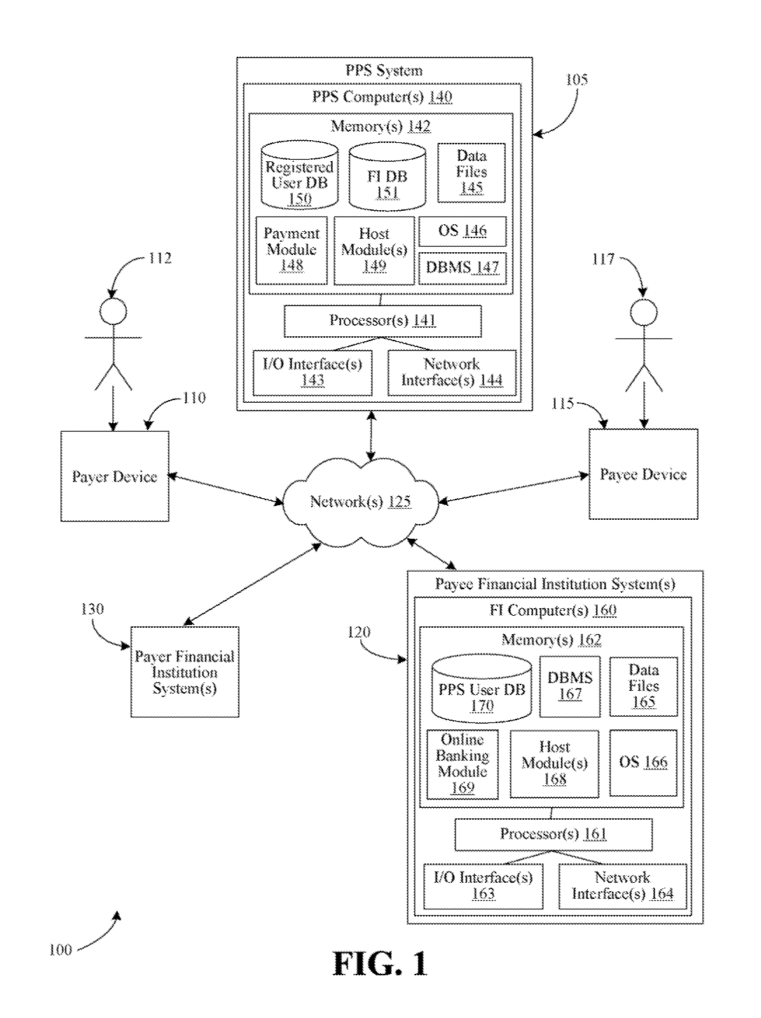

FIG. 1 illustrates an example system 100 for facilitating person-to-person payments, according to an example embodiment of the invention. Although various computing devices and/or computers are illustrated in FIG. 1, it is appreciated that corresponding entities and/or individuals are associated with each of the computers illustrated. According to various embodiments, there may be: one or more personal payment service (PPS) systems 105, each associated with one or more PPS computers 140 or PPS computing devices; one or more payers 112, each associated with one or more suitable payer devices 110 (e.g., computers, mobile devices, telephones, etc.); one or more payees 117, each associated with one or more suitable payee devices 115 (e.g., computers, mobile devices, telephones, etc.); and one or more financial institution systems (e.g., systems associated with banks), including one or more payee financial institution systems 120 that are each associated with one or more financial institution computers 160 and/or one or more payer financial institution systems 130 that are each associated with one or more suitable computers. According to various embodiments, there may be any number of each entity type, and each entity may be associated with any number of suitable computers, computing devices, and/or other devices. For simplicity, the computers, devices, and/or entities may be referenced in the singular, but it is appreciated that the same description applies to embodiments including multiple computers, devices and/or entities. Similarly, for each of the computers described herein, it is appreciated that the computer may include any number of suitable components and/or functionality.

As shown in FIG. 1, one or more of a PPS system 105, a payer device 110, a payee device 115, a payee financial institution system 120, and/or a payer financial institution system 130 may be in communication with each other via any number of suitable networks 125, which, as described below, can include one or more separate or shared private and/or public networks, including the Internet or a publicly switched telephone network. More specifically, according to various embodiments, the PPS system 105 may be operable to receive a payment request from a payer 112 via a suitable payer device 110. The PPS system 105 may then communicate with a designated payee 117 for the payment via a suitable payee device 115. In doing so, the PPS system 105 may identify a pre-existing account or registration of the payee 117 with the PPS system 105. The PPS system 105 may then complete the payment by communicating a credit directive to the payee financial institution system 120 and/or a debit directive to the payer financial institution system 130. Each of these components—the PPS system 105, the payer device 110, the payee device 115, the payee financial institution system 120, and the payer financial institution system 130—will now be discussed in further detail.

The PPS system 105 may be configured to receive payment requests from any number of payers 112 and process the payment requests to complete respective payments to any number of payees 117. The PPS system 105 may include any number of PPS computers 140 that facilitate the provision of a personal payment service. A PPS computer 140 may be any suitable processor-driven device that facilitates the receipt and/or processing payment requests that are received from payers 112, such as a server computer, a mainframe computer, one or more networked computers, a desktop computer, a personal computer, a digital assistant, a personal digital assistant, a digital tablet, an Internet appliance, an application specific circuit, microcontroller, minicomputer, or any other processor-based device. The execution of suitable computer-implemented instructions by the PPS computer 140 may form a special purpose computer or other particular machine that is operable to facilitate the processing of payment requests made by payers and/or the identification of a pre-existing account of a payee designated by a payment request. Although a single PPS computer 140 is described herein, the operations and/or control of the PPS computer 140 may be distributed amongst any number of computers and/or processing components.

In addition to having one or more processors 141, the PPS computer 140 may include one or more memory devices 142, one or more input/output (“I/O”) interface(s) 143, and one or more network interface(s) 144. The memory devices 142 may be any suitable memory devices, for example, caches, read only memory devices, random access memory devices, magnetic storage devices, removable storage devices, etc. Additionally, any number of logical data storage constructs may be stored as desired within the memory devices 142, such as any number of suitable databases. The memory devices 142 may store a wide variety of data, such as data files 145, a registered user database 150, and/or a financial institution database 151. Additionally, the memory devices 142 may store executable instructions and/or various program modules utilized by the PPS computer 140, for example, an operating system 146, a database management system (DBMS) 147, a payment module 148 and/or one or more host modules 149.

The data files 145 may include any suitable data that facilitates the receipt and/or processing of payment requests by the PPS computer 140. For example, the data files 145 may include data associated with pending or uncompleted payment requests. As desired, a database of pending payment requests may be provided. The registered user database 150 may include information associated with subscribers or registered users of the PPS system 105. Registered users may include registered payers and/or registered payees. In one example embodiment, the registered user database 150 may include information associated with registered users that are capable of receiving a payment via the PPS system 105. A wide variety of information may be stored for a registered user as desired in various embodiments of the invention, such as identifying information for the user, one or more contact identifiers for the user (e g., telephone numbers, mobile telephone number, social networking site identifiers, email addresses, etc.), and/or financial account information for the user (e.g., financial institution identifying information and/or account number information).

Similarly, the financial institution database 151 may include information associated with various financial institutions associated with the PPS system 105. These financial institutions may include partner financial institutions and/or non-partner financial institutions of the PPS system 105. A partner financial institution may be a financial institution having a pre-existing relationship with the PPS system 105 that facilitates enhanced communication between customers of the financial institution and the PPS system 105. For example, a partner financial institution may provide services to its customers, such as a personal payment service, through the PPS system 105. As desired, customer presentations (e.g., Web interfaces, etc.) provided by the PPS system 105 may be branded as services offered by a particular partner financial institution. A wide variety of information may be stored as desired in the financial institution database 151, including but not limited to, bank routing information associated with the financial institution and/or an identifier of whether a financial institution is a partner financial institution. For partner financial institutions, additional information may be stored, such as presentation and display preferences, various Web pages and/or messages to be presented to a customer of the financial institution, Web linking information, etc. The financial institution database 151 and/or the registered user database 150 may be stored in the memory devices 142 and/or stored by one or more external devices in communication with the PPS computer 140.

The operating system (OS) 146 may be a suitable software module that controls the general operation of the PPS computer 140. The OS 146 may also facilitate the execution of other software modules by the one or more processors 141, for example, the payment module 148 and/or the host module(s) 149. The OS 146 may be, but is not limited to, Microsoft Windows®, Apple OSX™, Linux, Unix, or a mainframe operating system. The host modules 149 may include any number of suitable host modules, such as Web servers, email servers, short message service (SMS) processing applications, and/or various modules associated with and/or in communication with automated dial-in and/or automated dialing systems associated with the PPS system 105. The host modules 149 may facilitate the receipt of a payment request from a payer 112 and/or communications with a designated payee 117 associated with a payment request. As set forth above, a wide variety of different types of host modules 149 may be provided. Additionally, in certain embodiments, the host modules 149 may be configured to generate and/or present a wide variety of different interfaces and/or graphical user interfaces, such as one or more public and/or private interfaces that facilitates the receipt of a payment request from a payer 112 and one or more public and/or private interfaces that facilitates communications with a payee 117. A public interface may be a Web page, mobile Web page, dial-in, and/or calling service that is generally available to the public. A private interface may be an interface that is restricted to registered users of the PPS system 105 and/or a partner entity (e.g., a partner financial institution) of the PPS system 105. As desired, a private interface may be branded in accordance with specifications and/or preferences of a partner entity. Additionally, as desired in certain embodiments, the host modules 149 may be configured to provide a Web services interface layer to another entity or component of the system 100. For example, the host modules 149 may provide a Web services interface layer by which a user interface (UI) of a partner financial institution system (e.g., a partner payee financial institution system 120) can access data and/or functionality of the PPS system 105.

The payment module 148 may be operable, configured, and/or programmed to receive information associated with a payment request made by a payer 112 and/or to process the received payment request. In operation, the payment module 148 may identify a designated payee 117 associated with the payment request by a first contact identifier that is included in the request, such as an email address, telephone number, social networking identifier, etc. The payment module 148 may determine whether the designated payee 117 is a registered user of the PPS system 105, for example, by searching the registered user database 150 utilizing the first contact identifier. According to an aspect of the invention, the payment module 148 may determine that the first contact identifier is not associated with a registered user of the PPS system 105, and the payment module 148 may generate an invitation or other message to the payee 117 informing the payee 117 of the availability of a payment and/or inviting the payee 117 to enroll or register with the PPS system 105. The payment module 148 may then direct the transmission or communication of the invitation to the payee 117 via the networks 125 utilizing the first contact identifier. For example, if the first contact identifier is an email address, then the payment module 148 may transmit an email message to an email host server associated with the payee 117. As another example, if the first contact identifier is a mobile telephone number, then the payment module 148 may transmit an SMS message to a mobile device (e.g., mobile phone) of the payee 117. As yet another example, if the first contact identifier is a telephone number, the payment module 148 may direct an automated dialing system to call the payee 117.

In addition to transmitting or communicating an invitation or message to the payee 117, the payment module 148 may direct the storage of information included in the payment request pending either registration of the payee 117 or the identification of a pre-existing account of the payee 117 with the PPS system 105. The invitation or message communicated to the payee 117 may include an indicator for the stored information associated with the payment request, such as a unique transaction code generated by the payment module 148 and/or a pointer to a memory location at which payment request information is stored. Additionally, in certain embodiments, the invitation or message may include contact information that facilitates the payee 117 contacting the PPS system 105 in order to register and/or access services of the PPS system 105, such as a Web address of the PPS system 105, a telephone number of the PPS system 105, etc. In certain embodiments, the invitation or message may include a link (e.g., a hyperlink) to or an address of a Web site hosted by the host module 149. A payee selection of the link or navigation to an address may establish a communications session between a payee device 115 and the Web site.

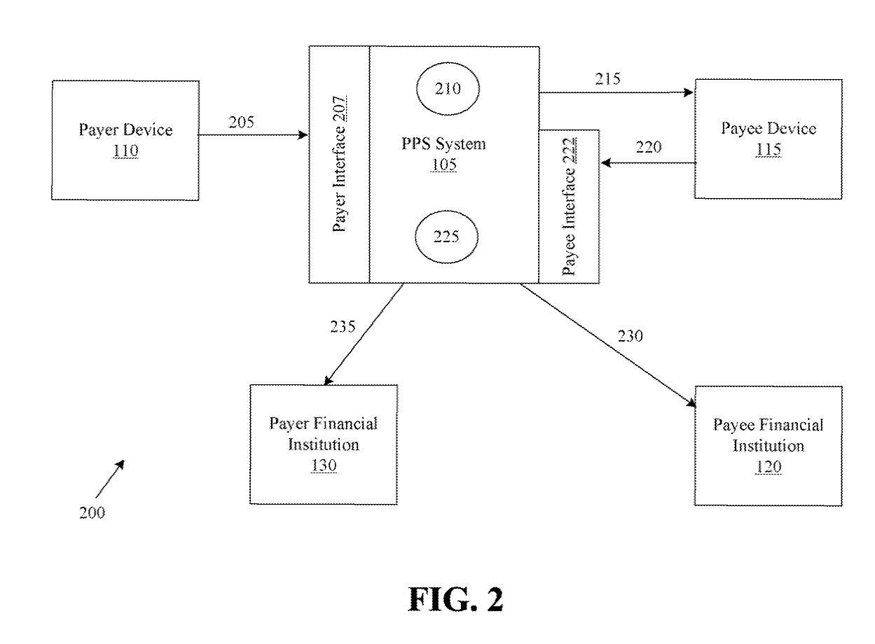

Once an invitation is communicated to a payee 117, the payee 117 may by presented the message utilizing an appropriate payee device 115. The payee 117 may then either register for a new account with the PPS system 105 in order to complete the payment or provide identifying information that may be utilized to determine or locate a pre-existing account of the payee 117 with the PPS system 105. A wide variety of identifying information for the payee 117 may be provided as desired in various embodiments of the invention, such as a contact identifier different than the first contact identifier that is associated with a pre-existing account and/or login information (e.g., user name and password), access credentials, and/or a security token associated with a pre-existing account. The transmitted indicator of stored information for the payment request may also be provided to the PPS system 105. The payee identifying information and/or indicator may be provided to the PPS system 105 in a wide variety of manners. For example, a payee device 115 may be utilized to directly provide the information to the PPS system 105. As another example; a payee device 115 may be linked to a partner financial institution of the PPS system 105, and the information may be provided by the partner financial institution and/or by the payee device 115 upon a redirection of the payee device 115 to the PPS system 105 by the partner financial institution. A few example data flows for receiving payee identifying information and/or an indicator are set forth in greater detail below with reference to FIGS. 2-4.

Based upon the receipt of payee identifying information, the payment module 148 may determine or identify a pre-existing registration or account of the payee 117 with the PPS system 105. The payment module 148 may access information associated with the pre-existing account, such as information associated with a financial account in which the payee 117 would like to receive payments. The payment module 148 may also utilize the received indicator to access stored information associated with the pending payment request. The pre-existing account information and the indicator may be utilized by the payment module 148 to complete the payment between the payer 112 and the payee 117. In one example embodiment, a credit directive or credit instruction may be transmitted or communicated to a payee financial institution system 120, directing, for example, a crediting of an account identified in the pre-existing account information for an amount corresponding to that of the pending payment request associated with the stored information. Additionally, as desired, a debit directive or debit instruction may be transmitted or communicated to a payer financial institution system 130.

According to an aspect of the invention, the payment module 148 may also save payee identifying information included in the payment request in association with a pre-existing account of a payee 117. For example, a first contact identifier included in the payment request may be stored in the registered user database 150 in association with the payee 117. In this regard, additional payments to the payee 117 based upon the first contact identifier may be facilitated without communicating an invitation message to the payee 117.

Although the payment module 148 is described above as receiving and processing a payment request received from a payer 112, in certain embodiments, the payment module 148 may additionally or alternatively be configured or programmed to receive requests from a payee 117 and process the received requests. For example, the payment module 148 may be configured to receive a request from a payee 117 to request a payment from an identified payer 112. The payment module 148 may then communicate or otherwise present, to the payer 112, a request for a payment to the payee 117. Additionally, the payment module 148 may determine whether the identified payer 112 is a registered user of the PPS system 105 in a similar manner as that described above for a payee 117. For example, if the payment module 148 is unable to identify a registration of the payer 112 utilizing received identifying information for the payer 112, the payment module 148 may communicate a registration invitation to the payer 112. In response to the invitation, the payment module 148 may either receive registration information for the payer 112 or information that may be utilized to identify a pre-existing registration or account of the payer 112 with the PPS system 105. As desired, a payer approval of the requested payment may also be received. A payment between the payer 112 and the payee 117 that requested the payment may then be facilitated by the payment module 148.

With continued reference to the PPS computer 140, the one or more I/O interfaces 143 may facilitate communication between the PPS computer 140 and one or more input/output devices, for example, one or more user interface devices, such as, a display, keypad, mouse, pointing device, control panel, touch screen display, remote control, microphone, speaker, etc. that facilitate user interaction with the PPS computer 140. The one or more network interfaces 144 may facilitate connection of the PPS computer 140 to one or more suitable networks, for example, the networks 125 illustrated in FIG. 1. In this regard, the PPS computer 140 may receive and/or communicate information to other components of the system 100, such as the payer device 110, the payee device 115, and/or the financial institutions 120, 130. As desired, any number of Web sites, interface screens, and/or other presentations (e.g., graphical user interfaces, telephone presentations, voice presentations, etc.) may be provided or presented to a payer 112 or payee 117 via the network interfaces 144.

With continued reference to FIG. 1, a payer 112 that requests a payment be made to a designated payee 117 may be associated with any number of payer devices 110. A payer device 110 may facilitate communication of the payment request to the PPS system 105 and/or other communications with the PPS system 105. A wide variety of payer devices may be utilized as desired in various embodiments of the invention, including but not limited to, personal computers, mobile devices (e.g., cell phones), personal digital assistants, telephones, etc. Each payer device may include a wide variety of components and/or functionality that facilitates the communication of a payment request to the PPS system 105. For example, a personal computer or Web-enabled device (e.g., a Web enabled mobile device) may be utilized to access a Web interface associated with a personal payment service of the PPS system 105 to request a payment be made to a payee. As another example, a personal computer or other device may be utilized to transmit an email with a payment request to the PPS system 105. As yet another example, a mobile device may be utilized to communicate an SMS message with a payment request to the PPS system 105. As yet another example, a telephone may be utilized to access a telephone-based payment service (e.g., an automated call in service) in order to request a payment. Each of the various types of payer devices 110 may include a wide variety of suitable components as desired in various embodiments of the invention. For example, a payee computer or a Web-enabled mobile device may be a suitable processor driven device that includes a client module, such as an Internet browser or other dedicated program, that facilitates communication with a host module 149 of the PPS system 105.

As desired, a suitable payer device 110 may additionally facilitate receipt of various messaged from the PPS system 105, such as a notification that a payment request has been received and/or a notification that a requested payment has been made to a payee 117. In certain embodiments, more than one payer device 110 may be utilized by a payer 112. For example, a first payer device may be utilized by the payer 112 to submit a payment request and a second payer device may be utilized by the payer 112 to receive a notification from the PPS system 105. In a similar manner, a payee 117 may utilize mutliple payee devices 115 as desired in various embodiments of the invention.

Similarly, a payee 117 may be associated with any number of suitable payee devices 115 that facilitate communication between the payee 117 and the PPS system 105, such as a personal computer, a mobile device, a personal digital assistant, a telephone, etc. The payee 117 may receive information associated with a payment request via a payee device 115, such as an invitation to register with a PPS system 105 and/or an indicator of information associated with a payment request. The payee 117 may then utilize the payee device 115 to establish a communications session with the PPS system 105 in order to provide the indicator to the PPS system 105 and identifying information for the payee 117 that may be utilized to identify or determine a pre-existing account of the payee 117 with the PPS system 105. For example, a payee 117 may utilize a personal computer or Web-enabled mobile device to access one or more Web sites hosted by the PPS system 105. In certain embodiments, the PPS system 105 may be accessed by selecting a link (e.g., a hyperlink) included in an invitation communicated to a payee device 115. Other types of payee devices 115 and/or communications techniques may be utilized as desired in various embodiments of the invention.

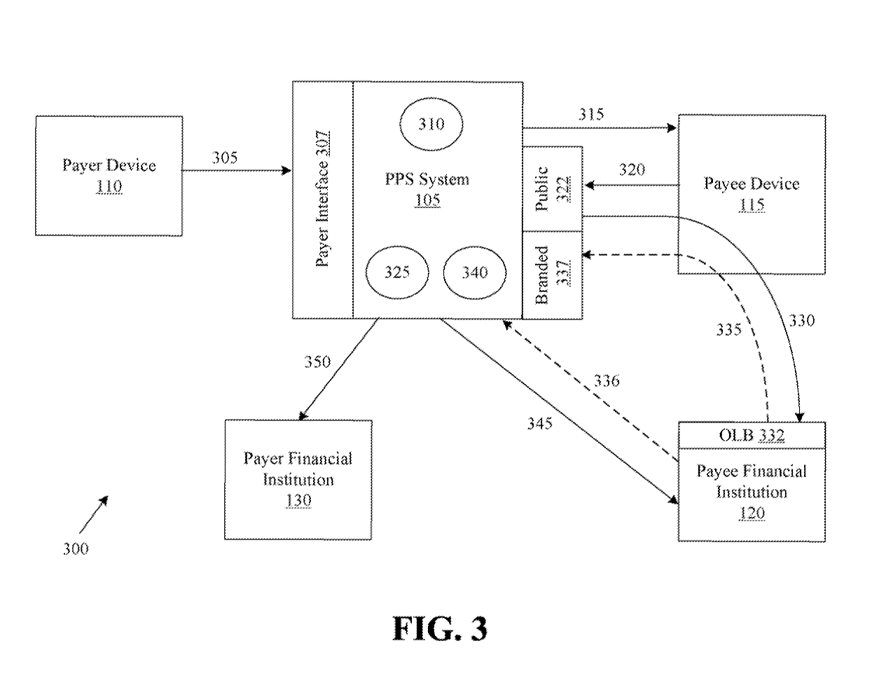

In certain embodiments of the invention, a payee 117 may communicate with a payee financial institution system 120 either in addition to or as an alternative to communicating with the PPS system 105. For example, a communications session between a payee device 115 and the PPS system 105 may be redirected to a payee financial institution system 120. As another example, a link or address communicated to a payee 117 may be configured to link a payee device 115 to a payee financial institution system 120. The payee financial institution system 120 may facilitate the collection of payee identifying information (e.g., a second contact identifier, login information, access credentials, etc.) that may be utilized to authenticate the payee 117 and/or determine a pre-existing account of the payee 117 with the PPS system 105. The payee financial institution system 120 may then either directly communicate payee identifying information to the PPS system 105 or communicate payee identifying information to the PPS system 105 during a redirection of the payee 117 to the PPS system 105. One example of a data flow 300 in which a payee 117 may be redirected to a financial institution system 120 is described in greater detail below with reference to FIG. 3.

With continued reference to FIG. 1, the payee financial institution system 120 may be configured to facilitate the provision of financial services to the payee 117 and/or the identification of a pre-existing registration of the payee 117 with the PPS system 105. The payee financial institution system 120 may be associated with a financial institution (e.g., bank) of the payee 117. Any number of payee financial institutions and/or associated systems 120 may be utilized as desired in various embodiments of the invention. Additionally, each payee financial institution system 120 may include or be associated with any number of financial institution computers 160 or computing devices. A financial institution (FI) computer 160 may be any suitable processor-driven device, such as a server computer, a mainframe computer, one or more networked computers, a desktop computer, a personal computer, a digital assistant, a personal digital assistant, a digital tablet, an Internet appliance, an application specific circuit, microcontroller, minicomputer, or any other processor-based device. The execution of suitable computer-implemented instructions by the FI computer 160 may form a special purpose computer or other particular machine that is operable to facilitate the provision of financial services, such as online banking services, to a payee customer of a financial institution system 120, including the authentication of the payee 117, and/or the identification of a pre-existing account of the payee 117 with a PPS system 105. Although a single FI computer 160 is described herein, the operations and/or control of the FI computer 160 may be distributed amongst any number of computers and/or processing components.

In addition to having one or more processors 161, the FI computer 160 may include one or more memory devices 162, one or more input/output (“I/O”) interface(s) 163, and one or more network interface(s) 164. The memory devices 162, I/O interfaces 163, and/or network interfaces 164 may be similar to those described above with reference to the PPS computer 140. As such, the memory devices 162 may store a wide variety of data and/or data repositories, such as data files 165, a personal payment service (PPS) user database 170. Additionally, the memory devices 162 may store executable instructions and/or various program modules utilized by the FI computer 160, for example, an operating system 166, a database management system (DBMS) 167, one or more host modules 168, and/or an online banking module 169.

The data files 165 may include, for example any suitable data that facilitates the identification and/or communication with the PPS system 105 and/or data associated with customers of the financial institution system 120. The PPS user database 170 may include information associated with customers of the financial institution system 120 that are registered for a personal payment service, such as a service provided by the PPS system 105 on behalf of the financial institution system 120. A wide variety of information may be stored for a registered user of a PPS service as desired in various embodiments of the invention, such as identifying information for the user, one or more contact identifiers for the user (e.g., telephone numbers, mobile telephone number, social networking site identifiers, email addresses, etc.), and/or login credentials, access credentials, and/or security tokens that may be utilized to authenticate the user such that a pre-existing account at the PPS system 105 for the user may be identified. The PPS user database 170 may be stored in the memory devices 162 and/or stored by one or more external devices in communication with the FI computer 160.

The operating system (OS) 166 may be a suitable software module that controls the general operation of the FI computer 160 and/or the execution of other software modules by the one or more processors 161. The OS 166 may be similar to the OS 146 for the PPS computer 140. The host modules 168 may also be similar to the host modules 149 of the PPS computer 140 and may include any number of suitable host modules, such as Web servers, email servers, and/or short message service (SMS) processing applications. In certain embodiments, a host module 168 may establish a communications session with a payee device 115 based upon either a selection of a link by a payee 117 or based upon a redirection from the PPS system 105. As desired, a host module 168 may also redirect a payee device 115 to a host module 149 of the PPS system 105.

The online banking module 169 may facilitate the provision of any number of suitable online banking services to a payee customer 117 of the financial institution system 120, such as, account access services, as well as access to other services that may be outsourced to other entities, such as bill presentment services, bill payment services, and/or personal payment services. In certain embodiments of the invention, the online banking module 169 may operate in conjunction with a host module 168 to facilitate the provision of these services. Additionally, in certain embodiments, the online banking module 169 may provide, a user interface layer for a personal payment service to a payee customer 117. For example, a payee 117 may access a personal payment service user interface within an online banking application hosted by the FI computer 160. Upon access, information associated with the PPS system 105 for which the payee 117 is registered may be accessed by the online banking module 169, for example, through a services interface layer of the host modules 149. Either the payee 117 or the FI computer 160 may then communicate at least a portion of the accessed information to the PPS system 105 to facilitate the completion of a pending payment.

A payer financial institution system 130 may be associated with a payer 112 that is requesting a payment be made to a payee 117. As desired, the payer financial institution system 130 may include similar components as the payee financial institution system 120. Additionally, in certain embodiments, a payer 112 and a payee 117 may utilize the same financial institution. During the processing of a payment between a payer 112 and a payee 117, a payer financial institution system 130 may receive an instruction or request to debit a financial account of a payer 112 for at least an amount of the payment being made to the payee 117.

The networks 125 may include any telecommunication and/or data networks, whether public, private, or a combination thereof, including but not limited to, a local area network, a wide area network, an intranet, the Internet, intermediate hand-held data transfer devices, public switched telephone networks, and/or any combination thereof and may be wired and/or wireless.

Those of ordinary skill in the art will appreciate that the system 100 shown in and described with respect to FIG. 1 is provided by way of example only. Numerous other operating environments, system architectures, and device configurations are possible. Other system embodiments can include fewer or greater numbers of components and may incorporate some or all of the functionality described with respect to the system components shown in FIG. 1. Accordingly, embodiments of the invention should not be construed as being limited to any particular operating environment, system architecture, or device configuration.

II. Operational Overview—Person-to-Person Payments

Embodiments of the invention may receive a request to make a payment to a designated payee, such as the payee 117 illustrated in FIG. 1, and identify a pre-existing account of the designated payee 117 with a PPS system, such as the PPS system 105 illustrated in FIG. 1. In this regard, a payment can be completed without the designated payer having to register a new account with the PPS system 105. According to an aspect of the invention, identifying information included in the received payment request may be utilized to transmit or otherwise communicate a message to the designated payee indicating that a payment is available and/or an invitation to access and/or enroll with the PPS system 105. In certain embodiments, the designated payee may provide the PPS system 105 with information associated with their pre-existing account with the PPS system 105, such as log-in information for a pre-existing account, one or more account identifiers, and/or identifying information associated with a pre-existing account. In other embodiments, the designated payee may provide the PPS system 105 with identifying information for a financial institution of the payee, such as the payee financial institution system 120 illustrated in FIG. 1. As desired in certain embodiments, the payee may then be redirected or linked to the financial institution system 120 in order to facilitate the identification of a pre-existing account of the payer with the PPS system 105.

FIGS. 2-4 illustrate example data flows for facilitating a person-to-person payment by a personal payment service system, according to example embodiments of the invention. FIG. 2 illustrates an example data flow 200 in which a payee provides a PPS system, such as the system 105 illustrated in FIG. 1, with information associated with a pre-existing account of the payee with the PPS system 105. In this regard, a payment from a payer to the payee may be facilitated by the PPS system 105.

With reference to FIG. 2, a payment request 205 may be received by the PPS system 105 from a device or system associated with a payer, such as the payer device 110 illustrated in FIG. 1. The payer may be a payer that is registered or enrolled with the PPS system 105 to complete or issue payments through the PPS system 105. In other words, the payer may be a subscriber for a payment service offered by the PPS system 105. In certain embodiments, the payer may have previously subscribed with the PPS system 105 via direct communication with the PPS system 105, such as through a Web site hosted by the PPS system 105, via email communicated to the PPS system 105, via snail mail, via telephone, etc. In other embodiments, the payer may have subscribed for a payment service via a partner entity of the PPS system 105, such as a partner financial institution of the PPS system 105.

The payment request 205 may be received from a wide variety of different types of payer devices as desired in various embodiments of the invention, including but not limited to, personal computers, personal digital assistants, mobile devices, telephones, etc. Additionally, the payment request 205 may be received via any number of suitable networks, such as the networks 125 illustrated in FIG. 1. Examples of suitable networks 125 include, but are not limited to, a wide area network, the Internet, a public-switched telephone network, etc. In order to facilitate the receipt of the payment request 205, the PPS system 105 may include any number of suitable network interfaces that facilitate connection of the PPS system 105 to the networks 125, such as the network interfaces 144 illustrated in FIG. 1. Additionally, the PPS system 105 may host or otherwise provide a wide variety of payer interfaces 207 that facilitate the receipt of the payment request 205, such as one or more Web sites or Web interfaces, one or more mobile Web interfaces, and/or a call center or public-switched telephone interface that may be accessed by the payer using a payer device 110. As desired, Web interfaces may include public Web interfaces associated with the PPS system 105, and/or branded Web interfaces associated with a partner of the PPS system 105, such as a partner financial institution of the PPS system 105. For example, a payer may access payment functionality from an online banking Website associated with their financial institution, and the financial institution may redirect the payer to a Web interface hosted by the PPS system 105 that is branded in accordance with specifications of the financial institution. The payer may then submit the payment request 205 to the PPS system 105. As another example, the payer may submit a payment request 205 to their financial institution, and the financial institution may forward or communicate the payment request 205 to the PPS system 105.

According to an aspect of the invention, the payment request 205 may include an identifier of a designated payee that the payer wishes to submit a payment to. A wide variety of suitable payee identifiers may be utilized as desired in various embodiments of the invention, including but not limited to, an email address, a telephone number, a mobile telephone number, a social networking identifier (e.g., a Facebook identifier, a MySpace identifier, etc.), etc.

Once the payment request 205 is received by the PPS system 105, the PPS system 105 may utilize the payee identifier in a determination of whether the payee is registered with the PPS system 105. In other words, the PPS system 105 may utilize the payee identifier to determine whether the payee has an account with the PPS system 105 that facilitates the direction of a payment to the payee. In certain embodiments, the payee identifier may be utilized to search a data repository of registered payees or registered payment recipients, such as the registered user database 150 illustrated in FIG. 1. For example, the payment identifier may be compared to any number of stored payment identifiers 210 associated with registered payees, subscribers, and/or users of the PPS system 105. If the PPS system 105 determines that the payee identifier included in the payment request 205 matches a stored payee identifier 210, then the PPS system 105 may determine that the payee has an account with the PPS system 105. The PPS system 105 may then access information associated with the payee's account, such as information associated with a financial account of the payee at a payee financial institution system 120, and utilize the information to direct or complete the requested payment. As desired, the PPS system 105 may perform additional verification prior to directing a payment. For example, the PPS system 105 may determine whether a payee name or other payee information included in the request 205 matches or partially matches a stored payee name or other stored payee information for the registered payee.

If, however, the PPS system 105 determines that the payee identifier included in the payment request 205 does not match a stored payee identifier 210, then the PPS system 105 may direct the storage of information associated with the payment request 205 (e.g., a copy of the request 205, information extracted from the request 205, etc.) pending enrollment of the payee or identification of a pre-existing account of the payee with the PPS system 105. The information associated with the request 205 may be stored in any number of suitable memory devices and/or corresponding data constructs associated with the PPS system 105. As desired, a unique transaction code or other unique identifier associated with the request 205 may be generated by the PPS system 105 and stored in association with other information for the request 205.

The PPS system 105 may also generate a message 215 for communication to a payee device associated with the designated payee, such as the payee device 115 illustrated in FIG. 1. The message 215 may include an indication that the payer desires to make a payment to the payee and/or an indication that the payee should either register with PPS system 105 or provide information associated with an existing account that the payee has with the PPS system 105 in order to receive the payment. As desired, the message 215 may include an invitation for the payee to register or enroll with the PPS system 105. In certain embodiments, the generated message 215 may further include a link (e.g., a hyperlink) or other information (e.g., a telephone number, universal resource locator, Web address, etc.) that the payee may utilize to access the PPS system 105. For example, a link may be included such that a payee selection of the link will establish a communications session between the payee device 115 and the PPS system 105. Additionally, the generated message 215 may include an indicator of the stored information associated with the payment request 205, such as a generated unique code or a location identifier for the stored information. In certain embodiments, the indicator may be displayed to the payee, and the payee may be required to provide the indicator to the PPS system 105 at a subsequent point in time. In other embodiments, the indicator may be embedded in the message 215 such that activation of a link included in the message will facilitate transmission of the indicator to the PPS system 105. For example, the activation of the link may cause a payee device 115 to access embedded information included in the message 215 and transmit the indicator to a Web server associated with the PPS system 105.

Once the message 215 is generated, the PPS system 105 may utilize the payee identifier included in the payment request 205 to directly or indirectly communicate the message 215 to a payee device 115 (e.g., computer, mobile device, telephone, etc.) associated with the payee. The message 215 may be communicated via any number of suitable networks 125. For example, if the payee identifier includes a mobile telephone number for the payee, then the message 215 may be communicated to a mobile payee device 115 via short message service (SMS) messaging and/or via a telephone call, such as a call that is completed by a call center or automated dialing center associated with the PPS system 105. As another example, if the payee identifier is an email address, then the message 215 may be formatted as an email and communicated to an email server that is accessible by a payee device 115. As yet another example, if the payee identifier is a social networking site identifier, then the message 215 may be communicated to an inbox or message board associated with the payee that is hosted by a social networking service provider.

Once the payee receives the message 215 via the payee device 115, the payee may utilize the payee device 115 (or another payee device) to access the PPS system 105. In certain embodiments, the payee may activate or select a link included in the message 215 and the selection of the link may establish a communications session with the PPS system 105. For example, the selection of the link may establish a communications session between the payee device 115 and a payee interface 222 that facilitates the receipt of information from the payee. A wide variety of payee interfaces 222 may be provided as desired in various embodiments of the invention, such as one or more Web sites or Web interfaces, one or more mobile Web interfaces, and/or a call center or public-switched telephone interface. In one embodiment, the selection of the link may establish a communications session between the payee device 115 and a public Website that is hosted by the PPS system 105.

During the established communications session, the payee may utilize the payee device 115 to transmit or otherwise communicate payee information 220 to the PPS system 105 that may be utilized to complete the payment. In certain embodiments, the payee information 220 may include payee identifying information that may be utilized by the PPS system 105 to identify a pre-existing account of the payee with the PPS system 105. Additionally, the payee information 220 may include the indicator of stored information associated with the payment request 205. A wide variety of payee identifying information may be communicated to the PPS system 105 as desired in various embodiments of the invention, including but not limited to, another payee identifier associated with a pre-existing account of the payee with the PPS system 105 and different than the payee identifier utilized to generate the message 215 and/or other suitable information associated with a pre-existing account of the payee with the PPS system 105, such as log-in information (e.g., user name, password, etc.), security tokens, and/or access credentials associated with a pre-existing account.

As an alternative to communicating the payee identifying information 220 and/or indicator of stored information to the PPS system 105 during a communications session established between a payee device 115 and the PPS system 105, the payee identifying information 220 may be communicated to the PPS system 105 utilizing any number of other suitable communication techniques, such as email, SMS messaging, etc. Additionally, as an alternative to the payee information 220 including payee identifying information, the payee information 220 may include registration or enrollment information that facilitates the establishment of a new account for the payee with the PPS system 105. Once a new account has been established for the payee, the PPS system 105 may complete the payment to the payee in order to fulfill the payment request 205.

Once payee information 220 is received by the PPS system 105, the PPS system 105 may utilize the received payee information 220 to access stored information 225 associated with the payee's pre-existing account with the PPS system 105 and/or the payment request 205 submitted by the payer. For example, the PPS system 105 may utilize a second payee identifier and/or log-in information provided by the payee to identify a pre-existing account of the payee with the PPS system 105, and the PPS system 105 may utilize the received indicator to identify stored information associated with the payment request 205. Once a pre-existing account is identified and/or accessed by the PPS system 105, information associated with the account, such as financial account information (e.g., a bank routing and account number) may be utilized to direct the completion of a payment associated with the payment request 205 to a financial account of the payee. For example, a financial account of the payee at a payee financial institution system 120 may be credited by an amount associated with the payment request 205. As shown in FIG. 2, the PPS system 105 may generate a credit directive 230, which may be a credit instruction instructing the payee financial institution system 120 to credit a financial account of the payee for a designated amount associated with the payment request 205, and the credit directive 230 may be communicated to the payee financial institution system 120. Additionally, as desired, the PPS system 105 may generate a debit directive 235, which may be a debit instruction associated with the payment request 205, and the debit directive 235 may be communicated to a financial institution associated with the payer, such as the payer financial institution system 130 illustrated in FIG. 1. In this regard, a payment from the payer to the payee may be completed. As desired, the PPS system 105 may withhold a portion of the amount credited to the payee in order to fund the services provided.

A wide variety of suitable communication networks 125 may be utilized to facilitate communication of the credit directive 235 and/or the debit directive 230 as desired in various embodiments of the invention. For example, an Automated Clearing House (ACH) network, banking network, etc. may be utilized to facilitate communication of the credit directive 235 and/or the debit directive 230.

Additionally, as desired, the PPS system 105 may store the payee identifier included in the payment request 205 in association with the identified pre-existing account of the payee. In this regard, if a subsequent payment request is received that identifies the payee by the same identifier, the account of the payee may be identified without communicating an invitation message to the payee.

FIG. 3 illustrates another example data flow 300 in which information associated with a pre-existing account of a payee with a PPS system is provided to the PPS system, such as the system 105 illustrated in FIG. 1. Portions of the data flow 300 illustrated in FIG. 3 may be similar to that described above with reference to FIG. 2. However, in the data flow 300 of FIG. 3, identifying information for the payee that may be utilized to identify a pre-existing account of the payee may be received by the PPS system 105 based upon a redirection of the payee to a partner financial institution of the PPS system 105.

With reference to FIG. 3, a payment request 305 may be received by the PPS system 105 from a device or system associated with a payer, such as the payer device 110 illustrated in FIG. 1. The payment request 305 may include similar information as and be received in a similar manner as the payment request 205 described above with reference to FIG. 2. For example, the payment request 305 may be received via one or more suitable payer interfaces 307 associated with the PPS system 105 that are similar to the payer interfaces 207 illustrated in FIG. 2. Once the payment request 305 is received, the PPS system 105 may utilize a payee identifier (e.g., a telephone number, email address, social networking identifier, etc.) to determine whether the designated payee has an account with the PPS system 105. For example, the payment identifier may be compared to any number of stored payment identifiers 310 associated with registered payees, subscribers, and/or users of the PPS system 105. Similar to the data flow of FIG. 2, if the PPS system 105 determines that the payee identifier included in the payment request 305 does not match a stored payee identifier 310, then the PPS system 105 may direct the storage of information associated with the payment request 305 (e.g., a copy of the request 305, information extracted from the request 305, a unique transaction code, etc.) pending enrollment of the payee or identification of a pre-existing account of the payee with the PPS system 105.

The PPS system 105 may also generate a message 315 for communication to a payee device associated with the designated payee, such as the payee device 115 illustrated in FIG. 1. The message 315 may be similar to the message 215 of FIG. 2. Accordingly, in certain embodiments, the message 315 may include an invitation for the payee to register or enroll with the PPS system 105 and/or a link (e.g., a hyperlink) or other information (e.g., a telephone number, universal resource locator, Web address, etc.) that the payee may utilize to access the PPS system 105. For example, a link may be included such that a payee selection of the link will establish a communications session between the payee device 115 and the PPS system 105. Additionally, the generated message 315 may include an indicator of the stored information associated with the payment request 305, such as a generated unique code or a location identifier for the stored information. Once generated, the message 315 may be communicated by the PPS system 105 to the payee device 115 in either a direct or indirect manner.

Once the payee receives the message 315 via the payee device 115, the payee may utilize the payee device 115 (or another payee device) to access the PPS system 105. In certain embodiments, the payee may activate or select the link included in the message 315 to establish a communications session with the PPS system 105. For example, the selection of the link may establish a communications session between the payee device 115 and a public payee interface 322 that facilitates the receipt of. information from the payee. A wide variety of public payee interfaces 322 may be provided as desired in various embodiments of the invention, such as one or more Web sites or Web interfaces, one or more mobile Web interfaces, and/or a call center or public-switched telephone interface that are generally made available to the public by the PPS system 105. In one embodiment, the selection of the link may establish a communications session between the payee device 115 and a public Website that is hosted by the PPS system 105.

During the established communications session, the payee may utilize the payee device 115 to transmit or otherwise communicate, to the PPS system 105, information 320 associated with a financial institution of the payee and/or a financial account of the payee at the financial institution. For example, the payee may provide at least a routing transit number (RTN) portion of a financial deposit account number to the PPS system 105. The RTN may be utilized by the PPS system 105 to identify a financial institution of the payee. As another example, the payee may provide a name of a financial institution to the PPS system 105. As yet another example, the payee may be presented with a list of partner financial institutions of the PPS system 105, and the payee may select their financial institution from the list.

Once the financial institution information 320 has been received by the PPS system 105, the PPS system 105 may utilize the received information 320 in order to determine whether the financial institution of the payee is a partner financial institution of the PPS system 105. For example, at least a portion of the received financial institution information 320 may be compared to information 325 included in a data repository of partner financial institution data, such as partner financial institution data stored in the financial institution database 151 of FIG. 1. A partner financial institution may be a financial institution with which the PPS system 105 has a pre-existing relationship, such as a relationship to provide payment services to customers of the financial institution. If the PPS system 105 finds a match between the received financial institution information 320 and the stored information 325 or a partner financial institution is selected by the payee, then the PPS system 105 may determine that the payee's financial institution is a partner financial institution.

The PPS system 105 may then redirect the payee to the financial institution, such as the payee financial institution system 120 illustrated in FIG. 1. As desired, the payee may be redirected to an interface provided by the financial institution system 120, such as an online banking interface 332 associated with the financial institution system 120. For example, a communications session between the payee device 115 and a public site hosted by the PPS system 105 may be redirected to an online banking Website or other suitable interface associated with the financial institution system 120. In certain embodiments, information 330 associated with the payment request, such as a unique transaction code or other indicator for the payment request, may be provided by the PPS system 105 or the payee device 115 to the financial institution system 120. Once communication has been established between the payee device 115 and the financial institution system 120, the payee may provide login information (e.g., a user name, password, etc.), security token information, and/or access credentials to the financial institution system 120 in order to access a service account of the payee at the financial institution system 120.

Once the payee has accessed a service account at the financial institution system 120, the financial institution system 120 may facilitate the communication of payee information 335 for the payee to the PPS system 105. The payee information 335 may include payee identifying information 335 that may be utilized by the PPS system 105 to identify a pre-existing account of the payee with the PPS system 105. Additionally, the payee information 335 may include the indicator (e.g., unique transaction code) of stored information associated with the payment request 305.

A wide variety of suitable techniques may be utilized as desired to facilitate the communication of payee information 335 to the PPS system 105. As one example, once the payee has accessed a service account at the financial institution system 120, the payee may navigate to a person-to-person payment, personal payment, or bill payment screen or functionality provided by the financial institution system 120. Upon invoking the payment functionality, the payee may be redirected to a suitable interface provided by the PPS system 105, such as an private or branded payee Web site or interface hosted by the PPS system 105. A branded Web site may be a site hosted by the PPS system 105 but branded in accordance with specification of the financial institution system 120. In this regard, it may appear to the payee that the Web site is hosted by the financial institution system 120. The redirection may be facilitated in many different manners. For example, the redirection may be automatically facilitated when the payee selects a suitable payment functionality. As another example, the financial institution system 120 may provide or display a selectable indicator of an available payment, such as a link indicating that a payment is available, and the redirection may be facilitated based upon a payee selection of the selectable indicator. Additionally, during the redirection, payee information 335, such as payee identifying information and an indicator of the payee, may be provided to the PPS system 105. For example, once the payee has been redirected to a branded site of the PPS system 105, a pre-existing account of the payee with the PPS system 105 may be identified by the PPS system 105.

Once the payee information 335 is received by the PPS system 105, the PPS system 105 may utilize the received payee information 335 to access stored information 340 associated with the payee's pre-existing account with the PPS system 105 and/or the payment request 305 submitted by the payer. For example, the PPS system 105 may utilize a second payee identifier included in the payee information 320 to identify a pre-existing account of the payee with the PPS system 105, and the PPS system 105 may utilize the received indicator to identify stored information associated with the payment request 305. As another example, the payee information 335 may include information that allows the identification of a pre-existing account based upon a successful login of the payee at the online banking interface 332 (e.g., an identifier of the payee) and an indicator of the stored information associated with the payment request 305. Once a pre-existing account is identified and/or accessed by the PPS system 105, information associated with the account, such as financial account information (e.g., a bank routing and account number) may be utilized to direct the completion of a payment associated with the payment request 305. For example, a credit directive 345 may be communicated to the financial institution system 120. Additionally, as desired, a debit directive 350 may be communicated to a financial institution associated with the payer, such as the payer financial institution system 130 illustrated in FIG. 1. As desired, any number of suitable Web interface screens and/or Web sites associated with receiving and/or accepting the payment may then be presented to the payee by the PPS system 105.

As another example of providing payee information 335 from the payee financial institution system 120 to the PPS system 105 and/or completing a payment, the payee may not be redirected to the PPS system 105 by the payee financial institution system 120. Instead, the financial institution system 120 may access information, software modules, and/or functionality of the PPS system 105 via any number of suitable Web service calls or other requests. In this regard, the payee financial institution system 120 may control communications with the payee device 115. As desired, the financial institution system 120 may identify a pre-existing account of the payee with the PPS system 105 and/or direct the crediting of a payee financial account to complete the payment. In certain embodiments, the payee financial institution system 120 may communicate information 336 associated with the identified pre-existing account and/or the credit to the PPS system 10$. Additionally, either the PPS system 105 or the payee financial institution system 120 may direct the payer financial institution system 130 to debit a financial account of the payer.

As yet another example of providing payee information 335 from the payee financial institution system 120 to the PPS system 105, a link included in a message communicated to a payee device 115 following the identification of a payee financial institution may be operable to link the payee device 115 directly to the payee financial institution system 120. The payee financial institution system 120 may then either redirect the payee to the PPS system 105 or directly communicate payee identifying information 335 to the PPS system 105 in order to facilitate the identification of a pre-existing account and the completion of a payment.

Additionally, as desired, the PPS system 105 may store the payee identifier included in the payment request 305 in association with the identified pre-existing account of the payee. In this regard, if a subsequent payment request is received that identifies the payee by the same identifier, the account of the payee may be identified without communicating an invitation message to the payee.

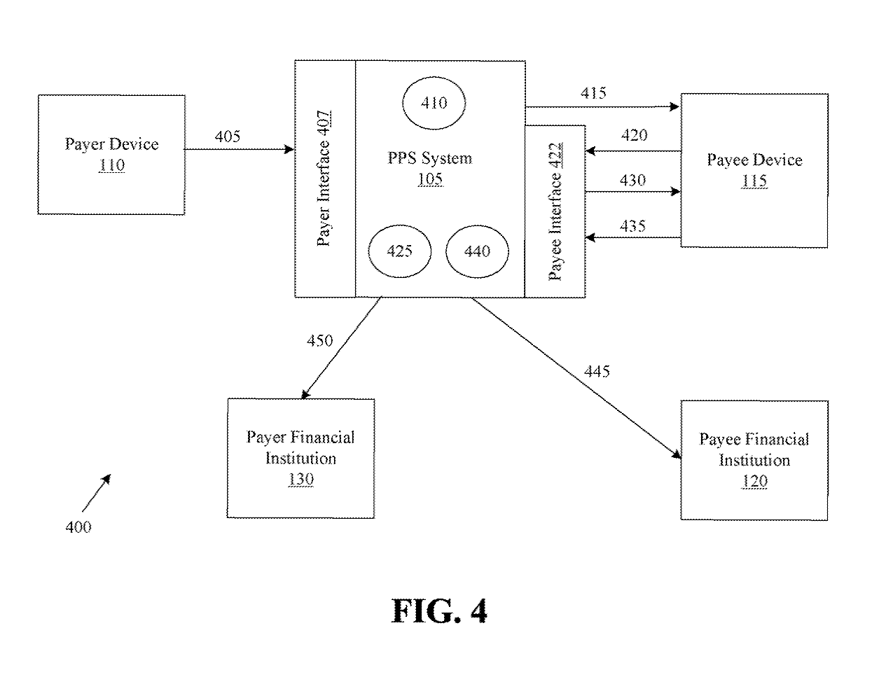

FIG. 4 illustrates another example data flow 400 in which information associated with a pre-existing account of a payee with a PPS system is provided to the PPS system, such as the system 105 illustrated in FIG. 1. Portions of the data flow 400 illustrated in FIG. 4 may be similar to that described above with reference to FIGS. 2 and 3. However, in the data flow 400 of FIG. 4, identifying information for the payee that may be utilized to identify a pre-existing account of the payee may be received by the PPS system 105 from the payee based upon a determination that a financial institution of the payee is not a partner financial institution of the PPS system 105.

With reference to FIG. 4, a payment request 405 may be received by the PPS system 105 from a device or system associated with a payer, such as the payer device 110 illustrated in FIG. 1. The payment request 405 may include similar information as and be received in a similar manner as the payment request 205 described above with reference to FIG. 2. For example, the payment request 405 may be received via one or more suitable payer interfaces 407 associated with the PPS system 105. Once the payment request 405 is received, the PPS system 105 may utilize a payee identifier (e.g., a telephone number, email address, social networking identifier, etc.) to determine whether the designated payee has an account with the PPS system 105. For example, the payment identifier may be compared to any number of stored payment identifiers 410 associated with registered payees, subscribers, and/or users of the PPS system 105. Similar to the data flow of FIG. 2, if the PPS system 105 determines that the payee identifier included in the payment request 405 does not match a stored payee identifier 410, then the PPS system 105 may direct the storage of information associated with the payment request 405 (e.g., a copy of the request 405, information extracted from the request 405, a unique transaction code, etc.) pending enrollment of the payee or identification of a pre-existing account of the payee with the PPS system 105.

The PPS system 105 may also generate a message 415 for communication to a payee device associated with the designated payee, such as the payee device 115 illustrated in FIG. 1. The message 415 may be similar to the message 215 of FIG. 2. Once generated, the message 415 may be communicated by the PPS system 105 to the payee device 115 in either a direct or indirect manner. Once the payee receives the message 415 via the payee device 115, the payee may utilize the payee device 115 (or another payee device) to access the PPS system 105. In certain embodiments, the payee may activate or select the link included in the message 415 to establish a communications session with the PPS system 105. For example, the selection of the link may establish a communications session between the payee device 115 and a public payee interface 422 that facilitates the receipt of information from the payee.

During the established communications session, the payee may utilize the payee device 115 to transmit or otherwise communicate, to the PPS system 105, information 420 associated with a financial institution of the payee and/or a financial account of the payee at the financial institution. For example, the payee may provide at least a routing transit number (RTN) portion of a financial deposit account number to the PPS system 105. As another example, the payee may provide a name of a financial institution to the PPS system 105. As yet another example, the payee may be presented with a list of partner financial institutions of the PPS system 105, and the payee may provide an indication that their financial institution is not included on the list, such as a by selecting an “other” option. Once the financial institution information 420 has been received by the PPS system 105, the PPS system 105 may utilize the received information 420 in order to determine whether the financial institution (e.g., financial institution system 120 illustrated in FIG. 1) of the payee is a partner financial institution of the PPS system 105. For example, at least a portion of the received financial institution information 420 may be compared to information 425 included in a data repository of partner financial institution data, such as partner financial institution data stored in the financial institution database 151 of FIG. 1. With reference to FIG. 4, the PPS system 105 may determine that the financial institution of the payee is not a partner financial institution.

Based upon the PPS system 105 determination that the payee financial institution system 120 is not a partner financial institution, the PPS system 105 may generate a message 430 requesting that the payee either provide the PPS system 105 with information associated with a pre-existing account or register to establish a new account with the PPS system 105. For example, the message 430 may include a prompt for the payee to provide login information and/or access credentials to the PPS system 105 along with the indicator (e.g., unique transaction code) of stored information associated with the payment request 405. Once generated, the message 430 may be communicated to the payee device 115 or presented to the payee 117 via the payee device 115, such as by a Web page presentation.

In response to the message 430, the payee may utilize the payee device 115 to transmit or otherwise communicate payee information 435 to the PPS system 105 that may be utilized to complete the payment, such as the indicator for the payment request 405 and/or payee identifying information associated with a pre-existing account (e.g., another payee identifier associated with a pre-existing account of the payee with the PPS system 105, log-in information, security tokens, and/or access credentials associated with a pre-existing account. The payee information 435 may be utilized by the PPS system 105 to access stored information 440 associated with the payee's pre-existing account with the PPS system 105 and/or the payment request 405 in a similar manner as that described above with reference to FIG. 2. Once a pre-existing account is identified and/or accessed by the PPS system 105, information associated with the account, such as financial account information (e.g., a bank routing and account number) may be utilized to direct the completion of a payment associated with the payment request 405. For example, a credit directive 445 may be communicated to the financial institution system 120. Additionally, as desired, a debit directive 450 may be communicated to a financial institution associated with the payer, such as the payer financial institution system 130 illustrated in FIG. 1.

Additionally, as desired, the PPS system 105 may store the payee identifier included in the payment request 405 in association with the identified pre-existing account of the payee. In this regard, if a subsequent payment request is received that identifies the payee by the same identifier, the account of the payee may be identified without communicating an invitation message to the payee.

It will be appreciated that many variations of the data flows 200, 300, 400 illustrated in FIGS. 2-4 may be utilized in accordance with various embodiments of the invention. For example, in certain embodiments, a payee request for a payment by an identified payer 112 may be received and processed. For example, a request for the PPS system 105 to request a payment from an identified payer 112 may be received from a suitable payee device 115. The PPS system 105 may then communicate or otherwise present, to the payer 112 via a suitable payer device 110, a request for a payment to the payee 117. Additionally, a determination may be made as to whether the identified payer 112 is a registered user of the PPS system 105, for example, by searching a data repository of registered users utilizing a payer identifier included in the information received from the payee 117. If it is determined that the payer 112 is not a registered user of the PPS system 105, then a registration invitation or an invitation to identify a pre-existing registration or account may be communicated by the PPS system 105 to a suitable payer device 110. In response to the invitation, the PPS system 105 may either receive registration information for the payer 112 or information that may be utilized to identify a pre-existing registration or account of the payer 112 with the PPS system 105. As desired, a payer approval of the requested payment may also be received. A payment between the payer 112 and the payee 117 that requested the payment may then be facilitated.

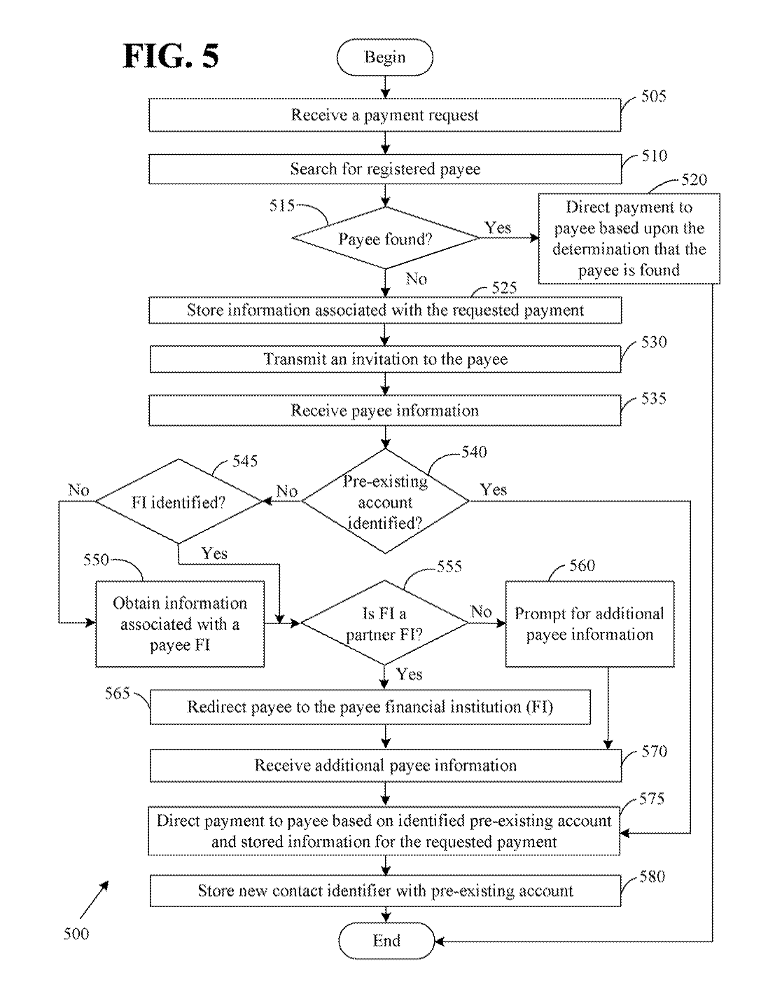

FIG. 5 is a flow chart of an example method 500 for facilitating a person-to-person payment, according to an example embodiment of the invention. In certain embodiments, the operations of the method 500 may be performed by one or more PPS computers associated with a PPS system, such as the PPS computers 140 associated with the PPS system 105 of FIG. 1. However, in other embodiments, certain operations of the method 500 may be performed by one or more other components, such as by one or more suitable financial institution systems. The method 500 may begin at block 505.

At block 505, a payment request may be received from a payer or on behalf of a payer. For example, a payment request may be received from a payer utilizing a suitable payer device, such as the payer device 110 illustrated in FIG. 1. The received payment request may identify or designate a payee with a first contact identifier for the payee, such as a telephone number, email address, social networking site identifier, etc. At block 510, a data repository of registered payees of the PPS system 105 may be searched utilizing the first contact identifier. In this regard, a determination may be made at block 515 as to whether the designated payee is a subscriber of the PPS system 105 that is capable of receiving payments via the PPS system 105. For example, if a match is found between the first contact identifier and a stored contact identifier associated with a registered payee, then the PPS system 105 may identify the designated payee as a registered payee.

If it is determined at block 515 that the designated payee is a registered payee or that information associated with the designated payee is found in a suitable data repository of registered payees, then operations may continue at block 520 and a payment may be directed to the designated payee utilizing stored information associated with the payee, such as a financial account number, financial institution identifier, etc. For example, a credit directive may be communicated to a financial institution of the payee. Additionally, as desired, a debit directive may be communicated to a financial institution of the payer. Operations may then end.

If, however, it is determined at block 515 that the designated payee is not found in a data repository or that the designated payee is not registered under the first contact identifier, then operations may continue at block 525. At block 525, information associated with the requested payment may be stored in a suitable data repository pending registration of the designated payee with the PPS system 105 or pending the identification of a pre-existing account associated with the designated payee. Operations may then continue at block 530 and an invitation or other suitable message may be generated and transmitted to the designated payee utilizing the first contact identifier. The invitation may include a wide variety of different information as desired in various embodiments of the invention, such as an indication that a payment is available for the payee, an invitation for the payee to register with the PPS system 105, contact information associated with the PPS system 105, a link (e.g., a hyperlink) to or Web address of the PPS system 105 and/or an indicator (e.g., a unique transaction code, pointer, or other identifier) of the stored information associated with the payment request. The invitation may be transmitted to the payee either directly or indirectly via a wide variety of different communications networks and/or communications techniques, as described above with reference to FIG. 2.

At block 535, information for the payee may be received. In certain embodiments, such as those described above with reference to FIGS. 2-4, payee information, such as payee identifying information and/or information identifying a financial institution of the payee, may be received as a result of the payee establishing a communications session or other contact with the PPS system 105. For example, a payee may select a link included in an invitation to establish a communications session between a payee device 115 and the PPS system 105. As described above with reference to FIGS. 2-4, a wide variety of different types of payee information may be received as desired in various embodiments of the invention, such as identifying information (e.g., a second contact identifier), login information, access credentials and/or information identifying a financial institution of the payee, that may be utilized to identify and/or access a pre-existing account of the payee. In certain embodiments, the indicator of stored information associated with the payment request may also be received in conjunction with the payee information.

At block 540, a determination may be made as to whether the received payee information can be utilized to identify a pre-existing account of the payee with the PPS system 105. For example, as described in greater detail above with reference to FIG. 2, a determination may be made as to whether the received payee information includes a second identifier of the payee, login information, and/or access credentials that may be utilized to identify a pre-existing account of the payee. If a pre-existing account is identified at block 540, then operations may continue at block 575 below and a payment to the payee may be completed. If, however, a pre-existing account is not identified at block 540, then operations may continue at block 545.

At block 545, a determination may be made as to whether a financial institution of the payee can be identified based upon the received payee information. For example, a determination may be made as to whether the payee information includes a routing number, name, or other identifier of a payee financial institution. If it is determined at block 545 that a financial institution is identified, then operations may continue at block 555 described in greater detail below. lf, however, it is determined at block 545 that a financial institution is not identified, then operations may continue at block 550 and information associated with a financial institution of the payee may be obtained utilizing any number of suitable techniques. For example, a payee may be prompted to select their financial institution from a provided list of financial institutions or to provide a name, at least an RTN portion of a payee financial account, or other identifying information for a payee financial institution. Information received in response to the prompt may then be utilized to identify the payee financial institution. Operations may then continue at block 555.

At block 555, a determination may be made as to whether the payee financial institution is a partner financial institution of the PPS system 105. For example, an indication and/or identifying information for a payee financial institution may be utilized to search a data repository of partner financial institutions. As another example, a determination may be made as to whether a financial institution selected from a list is a partner financial institution. If it is determined at block 555 that the payee financial institution is not a partner financial institution of the PPS system 105, then operations may continue at block 560 and the payee may be prompted for additional information that may be utilized to identify a pre-existing account of the payee, such as identifying information for a pre-existing account and/or access credentials for the payee. In response to the prompt, identifying information for the payee or login information and/or access credentials that may be utilized to identifying a pre-existing account may be received at block 570 described in greater detail below. For example, identifying information, login information, and/or access credentials may be received in a similar manner as that set forth above with reference to FIG. 4.

If, however, it is determined at block 555 that the payee financial institution is a partner financial institution of the PPS system 105, then operations may continue at block 565 and the payee may be redirected to a payee financial institution system, such as the system 120 illustrated in FIG. 1. Additional information for the payee and the indicator for stored information associated with the payment request may then be received at block 570 from the payee financial institution system 120 or as a result of a redirection of the payee from the payee financial institution system 120 back to the PPS system 105. For example, payee identifying information and the indicator may be received in a similar manner as that set forth above with reference to FIG. 3.

At block 570, additional payee information may be received utilizing a wide variety of suitable techniques as desired in various embodiments of the invention. The additional information may be utilized at block 575 to identify a pre-existing account of the payee with the PPS system 105. The identified pre-existing account and stored information associated with the requested payment, which may be accessed utilizing a received indicator, may be utilized to direct a payment to the payee. For example, a credit directive for at least a portion of a payment amount included in the payment request may be issued to a financial account of the payee associated with the pre-existing account. Additionally, as desired, a directive to debit a financial account of the payer may be issued. As desired, the PPS system 105 may charge a reasonable fee for the payment service. The charge may be withheld from the payment amount identified in the payment request or added to a debit amount that is communicated to a financial institution of the payer.

At block 580, which may be optional in certain embodiments of the invention, the first contact identifier included in the payment request may be stored in association with the pre-existing registration or pre-existing account of the payee with the PPS system 105. In this regard, subsequent payment requests that include the first contact identifier may be processed by the PPS system 105 without communicating an invitation message to the payee.

The method 500 may end following either block 520 or 580.

The operations described and shown in the method 500 of FIG. 5 may be carried out or performed in any suitable order as desired in various embodiments of the invention. Additionally, in certain embodiments, at least a portion of the operations may be carried out in parallel. Furthermore, in certain embodiments, less than or more than the operations described in FIG. 5 may be performed. Additionally, although the method 500 of FIG. 5 describes a method in which payment requests are received from a payer, similar operations may be utilized to process the receipt of requests, from a payee, for payment by an identified or designated payer.

The invention is described above with reference to block and flow diagrams of systems, methods, apparatuses, and/or computer program products according to example embodiments of the invention. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the invention.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the invention may provide for a computer program product, comprising a computer usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Many modifications and other embodiments of the invention will come to mind to one skilled in the art to which this invention pertains and having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

The claimed invention is:

1. A method, comprising:
receiving, by a payment service provider system comprising one or more computers, a request on behalf of a payer to pay a payee, wherein the request identifies the payee via a first contact identifier;
upon failing to locate the payee in a data repository of registered payees via the first contact identifier, transmitting, to the payee by the payment service provider system and utilizing the first contact identifier, an invitation for the payee to register with the payment service provider and receive a payment corresponding to the request, wherein information associated with the request is stored pending registration by the payee, and wherein the invitation comprises a link to a site of the payment service provider and an indicator of the stored information;
receiving, by the payment service provider system and based at least in part upon a payee selection of the link, (i) identifying information for the payee other than the first contact identifier and (ii) the indicator of the stored information;
determining, by the payment service provider system utilizing the received identifying information, a pre-existing registration of the payee with the payment service provider, wherein the pre-existing registration is associated with a second contact identifier and a financial account at a financial institution for receiving funds;
accessing, by the payment service provider system utilizing the received indicator, the stored information; and
directing, by the payment service provider system, the payment to the payee based on the stored information, wherein the payment comprises crediting funds into the financial account.

2. The method of claim 1, further comprising:
storing, by the payment service provider system, the first contact identifier in association with the pre-existing registration.

3. The method of claim 1, further comprising:
receiving, by the payment service provider system from the payee, an identification of a financial institution at which the payee wishes to receive the payment.

4. The method of claim 3, further comprising:
determining, by the payment service provider system, that the indicated financial institution is a partner financial institution; and
responsive to determining that the financial institution is a partner financial institution, redirecting, by the payment service provider system, the payee to a site of the financial institution,
wherein the identifying information for the payee and the indicator are received subsequent to redirecting the payee.

5. The method of claim 4, wherein receiving the identifying information and the indicator comprises receiving the identifying information and the indicator in a communication session established by the partner financial institution redirecting the payee to the payment service provider system.

6. The method of claim 4, wherein receiving the identifying information and the indicator comprises receiving the identifying information and the indicator from the partner financial institution.

7. The method of claim 3, further comprising:
determining by the payment service provider system, that the financial institution is not a partner financial institution,
wherein receiving identifying information for the payee comprises receiving the identifying information from the payee responsive to determining that the financial institution is not a partner financial institution by the payment service provider system.

8. The method of claim 7, further comprising:
receiving, by the payment service provider system from the payee, at least one of a security token or access credentials associated with the pre-existing registration of the payee with the payment service provider.

9. The method of claim 1, wherein transmitting an invitation comprises transmitting an invitation including the link with the indicator embedded in information associated with the link such that activation of the link facilitates communication of the indicator to the payment service provider system.

10. The method of claim 1, wherein transmitting an invitation comprising an indicator comprises transmitting an invitation comprising a unique transaction code associated with the stored information.

11. The method of claim 1, further comprising:
transmitting, by the payment service provider system to a financial institution associated with the payer, a direction to debit a financial account of the payer.

12. A system, comprising:
at least one communications interface configured to (i) receive a request on behalf of a payer to pay a payee, wherein the request identifies the payee via a first contact identifier, (ii) transmit, to the payee utilizing the first contact identifier, an invitation for the payee to register with a payment service provider and receive a payment corresponding to the request, wherein the invitation comprises a link to a site of the payment service provider and an indicator of stored information associated with the request, and (iii) receive, based at least in part upon a payee selection of the link, identifying information for the payee other than the first contact identifier and the indicator of the stored information; and
at least one processor configured to (i) search a data repository of registered payees via the first contact identifier, (ii) upon failing to locate the payee in the search, direct the transmission of the invitation and store the information associated with the request pending registration by the payee, (iii) determine, utilizing the received identifying information, a pre-existing registration of the payee with the payment service provider, wherein the pre-existing registration is associated with a second contact identifier and a financial account at a financial institution for receiving funds, (iv) access, utilizing the received indicator, the stored information, and (v) direct the payment to the payee based on the stored information, wherein the payment comprises crediting funds into the financial account.

13. The system of claim 12, wherein the at least one processor is further configured to store the first contact identifier in association with the pre-existing registration.

14. The system of claim 12, wherein the at least one communications interface is further configured to receive, from the payee, an identification of a financial institution at which the payee wishes to receive the payment.

15. The system of claim 14, wherein the at least one processor is further configured to (i) determine that the indicated financial institution is a partner financial institution of the payment service provider and (ii) responsive to the determination, redirect the payee to a site of the financial institution, wherein the identifying information for the payee and the indicator are received subsequent to redirecting the payee.

16. The system of claim 15, wherein the identifying information and the indicator is received by the at least one communications interface in a communication session established by the partner financial institution redirecting the payee to the payment service provider.

17. The system of claim 15, wherein the identifying information and the indicator is received by the at least one communications interface from the partner financial institution.

18. The system of claim 14, wherein the at least one processor is further configured to (i) determine that the financial institution is not a partner financial institution of the payment service provider, and
wherein the identifying information for the payee is received from the payee responsive to determining that the financial institution is not a partner financial institution.

19. The system of claim 18, wherein the at least one communications interface is further configured to receive, from the payee, at least one of a security token or access credentials associated with the pre-existing registration of the payee with the payment service provider.

20. The system of claim 12, wherein the invitation comprises embedded information associated with the link such that activation of the link facilitates communication of the indicator to the payment service provider system.

21. The system of claim 12, wherein the indicator comprises a unique transaction code associated with the stored information.

22. The system of claim 12, wherein the at least one processor is further configured to direct a financial institution associated with the payer to debit a financial account of the payer.

23. A method, comprising:
receiving, by a payment service provider system comprising one or more computers, a first request on behalf of a payee to transmit a second request for a payment from a payer, wherein the first request identifies the payer via a first contact identifier;
upon failing to locate the payer in a data repository of registered payers via the first contact identifier, transmitting, to the payer by the payment service provider system and utilizing the first contact identifier, an invitation for the payer to register with the payment service provider and the second request, wherein information associated with the first request is stored pending registration by the payer, and wherein the invitation comprises a link to a site of the payment service provider and an indicator of the stored information;
receiving, by the payment service provider system and based at least in part upon a payer selection of the link, (i) identifying information for the payer other than the first contact identifier and (ii) the indicator of the stored information;
determining, by the payment service provider system utilizing the received identifying information, a pre-existing registration of the payer with the payment service provider, wherein the pre-existing registration is associated with a second contact identifier and a financial account of the payer at a payer financial institution;
accessing, by the payment service provider system utilizing the received indicator, the stored information; and
directing, by the payment service provider system, the payment to the payee based on the stored information, wherein the payment comprises debiting funds from the financial account.
